(19) United States
(12) Patent Application Publication
(10) Pub. No.: US 2015/0327287 A1
(43) Pub. Date: Nov. 12, 2015

(54) METHOD FOR SUPPORTING COORDINATED MULTI-POINT TRANSMISSION AND RECEPTION SCHEME IN WIRELESS COMMUNICATION SYSTEM AND DEVICE FOR THE SAME

(71) Applicant: LG ELECTRONICS INC., Yeongdeungpo-gu Seoul (KR)

(72) Inventors: Eunsun KIM, Anyang-si, Gyeonggi-do (KR); Kijun KIM, Anyang-si, Gyeonggi-do (KR)

(73) Assignee: LG ELECTRONICS INC., Seoul (KR)

(21) Appl. No.: 14/761,216

(22) PCT Filed: Sep. 3, 2013
(86) PCT No.: PCT/KR2013/007940

§ 371 Date: Jul. 15, 2015

Related U.S. Application Data
(60) Provisional application No. 61/755,448, filed on Jan. 22, 2013.

(51) Int. Cl. H04W 72/12; H04B 17/309; H04B 7/02

(52) U.S. Cl. CPC H04W 72/121; H04B 7/024; H04B 17/309

(57) ABSTRACT

According to one embodiment of the present invention, a method by which a coordinated multi-point transmission and reception (CoMP) scheduling device supports communication of a CoMP cluster in a wireless communication system supporting CoMP can comprise the steps of: receiving channel state information (CSI) measured by at least one terminal served by at least one base station in the CoMP cluster; selecting terminal(s) to be served as a CoMP operation on the basis of the received CSI measured by the at least one terminal and determining scheduling information for the selected terminal(s); and transmitting the scheduling information for the selected terminal(s) to at least one base station for serving the CoMP operation of the selected terminal(s).

### TECHNICAL FIELD

The present invention relates to a wireless communication system and, more specifically, to a method for supporting coordinated multi-point transmission and reception (CoMP) in a wireless communication system.

### BACKGROUND ART

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### DISCLOSURE

### Technical Problem

An object of the present invention is to provide a method for efficiently determining a CoMP cluster in a wireless communication system.

Another object of the present invention is to provide a method for determining a CoMP cluster through an X2 interface.

The technical problems solved by the present invention are not limited to the above technical problems and those skilled in the art may understand other technical problems from the following description.

### Technical Solution

According to one aspect of the present invention, a method for supporting communication of a coordinated multi-point transmission and reception (CoMP) cluster by a CoMP scheduling device in a wireless communication system supporting CoMP includes: receiving channel state information (CSI) measured by at least one terminal served by at least one base station in the CoMP cluster; selecting one or more terminals to be served through a CoMP operation based on the received CSI measured by the at least one terminal and determining scheduling information for the selected terminals; and transmitting the scheduling information for the selected terminals to at least one base station for serving the CoMP operation of the selected UEs.

Preferably, the scheduling information for the selected terminals may include at least one of identifiers of the selected terminals, modulation and coding scheme (MCS) and a precoding matrix indicator (PMI) allocated to the selected terminals.

Preferably, the scheduling information for the selected terminals may include at least one of the identifiers of the selected terminals, resource block information and a PMI allocated to the selected terminals.

Preferably, the at least one base station may transmit downlink data to the selected terminals based on the scheduling information for the selected terminals, and only one base station from among the at least one base station may transmit downlink data to one of the selected terminals at a specific timing.

Preferably, The method may further include acquiring feedback information about reception of the downlink data from the selected terminals.

Preferably, the CoMP scheduling device may be a base station in the CoMP cluster.

Preferably, the method may further include transmitting a specific TCP/IP packet for the selected terminals to at least one base station in the CoMP cluster prior to the determining of the scheduling information.

Preferably, the method may further include generating a transport block based on the scheduling information.

According to another embodiment of the present invention, a method for performing communication of a CoMP cluster by a base station in the CoMP cluster in a wireless communication system supporting CoMP includes: transmitting CSI, measured by at least one terminal served by the base station, to a scheduling device; and receiving, from the scheduling device, scheduling information for one or more terminals to be served through a CoMP operation selected based on the CSI measured by the at least one terminal.

Preferably, the scheduling information for the selected terminals may include at least one of identifiers of the selected terminals, MCS and a PMI allocated to the selected terminals.

Preferably, the scheduling information for the selected terminals may include at least one of the identifiers of the selected terminals, information about resource block and a PMI allocated to the selected terminals.

Preferably, the method may further include selecting an MCS for the selected terminals.

Preferably, the method may further include transmitting downlink data to the selected terminals based on the scheduling information for the selected terminals, wherein the base station is a unique base station transmitting downlink data to one of the selected terminals at a specific timing.

Preferably, the method may further include acquiring feedback information about reception of the downlink data from the selected terminals.

Preferably, the method may further include receiving a specific TPC/IP packet for the selected terminals from the scheduling device prior to transmitting CSI.

Preferably, The method may further include generating a transport block based on the scheduling information and segmenting a code block according to a size of the generated transport block.

The aforementioned technical solutions are merely parts of embodiments of the present invention and various embodiments in which the technical features of the present invention are reflected can be derived and understood by a person skilled in the art based on the following detailed description of the present invention.

### Advantageous Effects

According to an embodiment of the present invention, it is possible to efficiently determine a CoMP cluster in a wireless communication system.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates an exemplary radio frame structure used in a wireless communication system;

FIG. 2 illustrates an exemplary downlink/uplink (DL/UL) slot structure in a wireless communication system;

FIG. 3 illustrates a downlink (DL) subframe structure used in 3GPP LTE/LTE-A;

FIG. 4 illustrates an exemplary uplink (UL) subframe structure used in 3GPP LTE/LTE-A;

FIG. 5 illustrates channel state information-reference signal (CSI-RS) patterns used in 3GPP LTE/LTE-A;

FIG. 6 illustrates a wireless communication system according to embodiment(s) of the present invention;

FIG. 7 illustrates a wireless communication system according to embodiments of the present invention;

FIG. 8 illustrates a wireless communication system according to embodiments of the present invention;

FIG. 9 illustrates a wireless communication system according to embodiments of the present invention;

FIG. 10 illustrates a wireless communication system according to embodiments of the present invention;

FIG. 11 illustrates an operation according to embodiments of the present invention;

FIG. 12 illustrates an operation according to embodiments of the present invention;

FIG. 13 illustrates an operation according to embodiments of the present invention;

FIG. 14 illustrates an operation according to embodiments of the present invention;

FIG. 15 illustrates an operation according to embodiments of the present invention;

FIG. 16 illustrates an operation according to embodiments of the present invention; and

FIG. 17 is a block diagram of an apparatus for implementing embodiments of the present invention.

### BEST MODE

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term BS' may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming) DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowlegement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

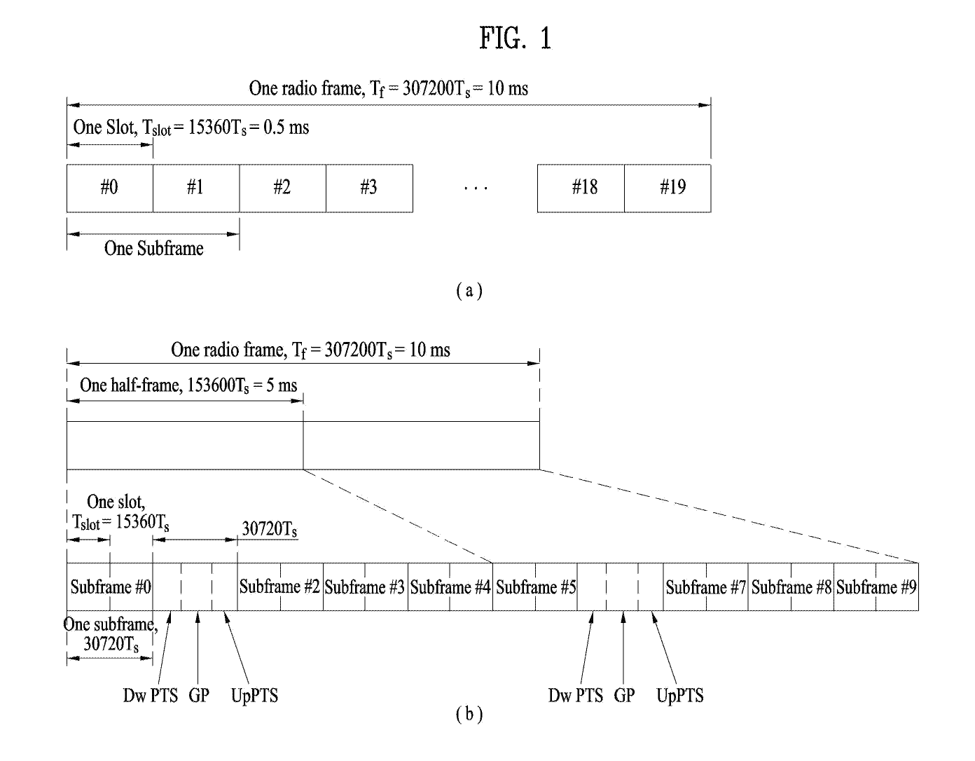

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| | to-Uplink | | | | | | | | | | |
| DL-UL | Switch-point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | DwPTS | cyclic prefix | cyclic prefix |
| configuration | DwPTS | in uplink | in uplink | ee | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

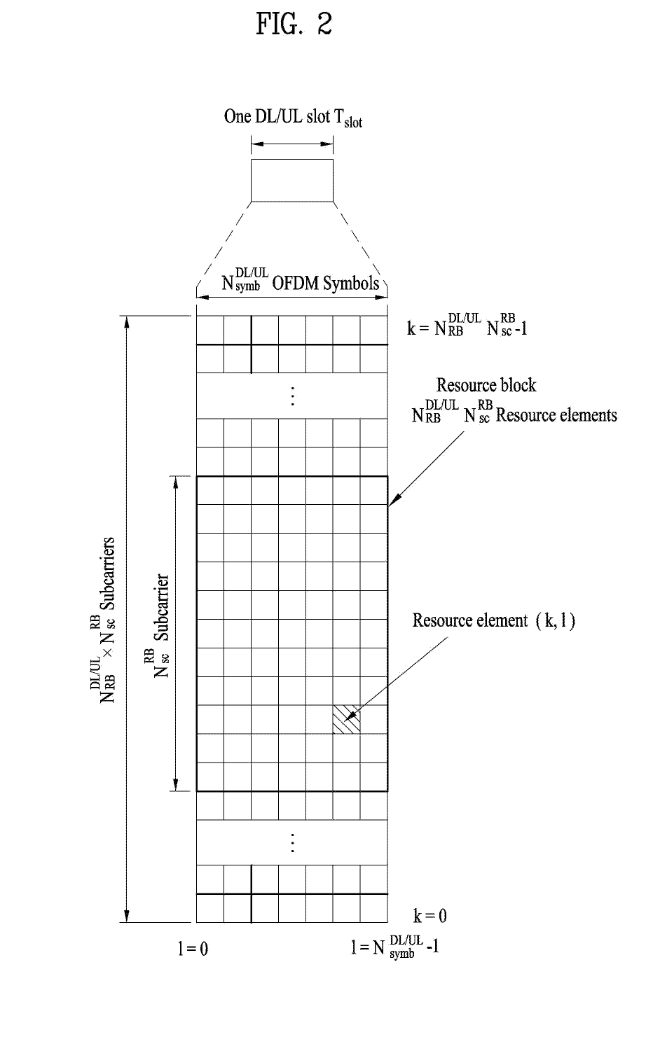

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} RB and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g. 7) consecutive OFDM symbols in the time domain and N_{sc}^{RB} (e.g. 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and 1 is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

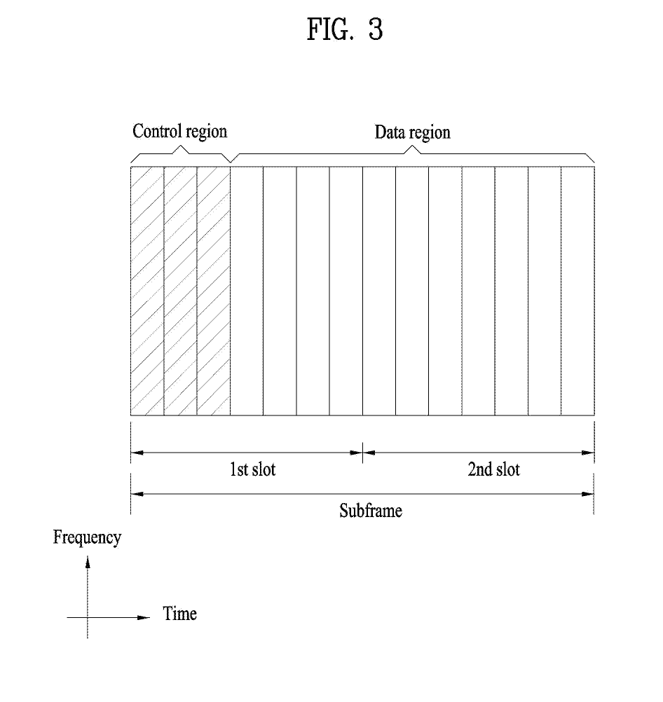

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space are as follows:

TABLE 3

| Search Space | | | Number of |
|---|---|---|---|
| | Aggregation | Size | PDCCH |
| Type | Level L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g. frequency position) of “B” and transmission format information (e.g. transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

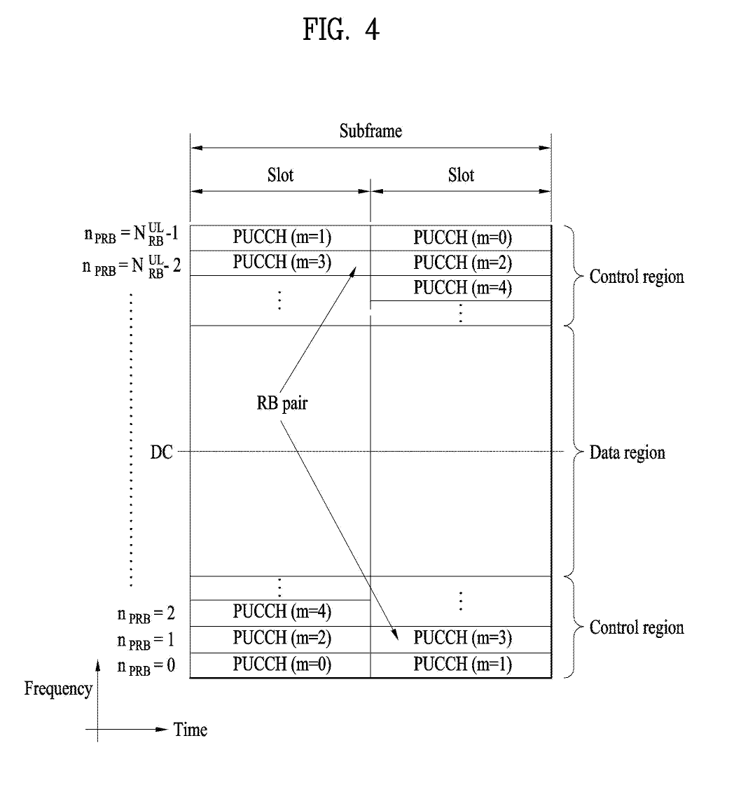

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (00K) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (HACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon. Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + BPSK | 21 | CQI/PMI/RI + | Normal CP |
| | | | ACK/NACK | only |
| 2b | QPSK + QPSK | 22 | CQI/PMI/RI + | Normal CP |
| | | | ACK/NACK | only |
| 3 | QPSK | 48 | ACK/NACK or | |
| | | | SR + ACK/NACK | |
| | | | or CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

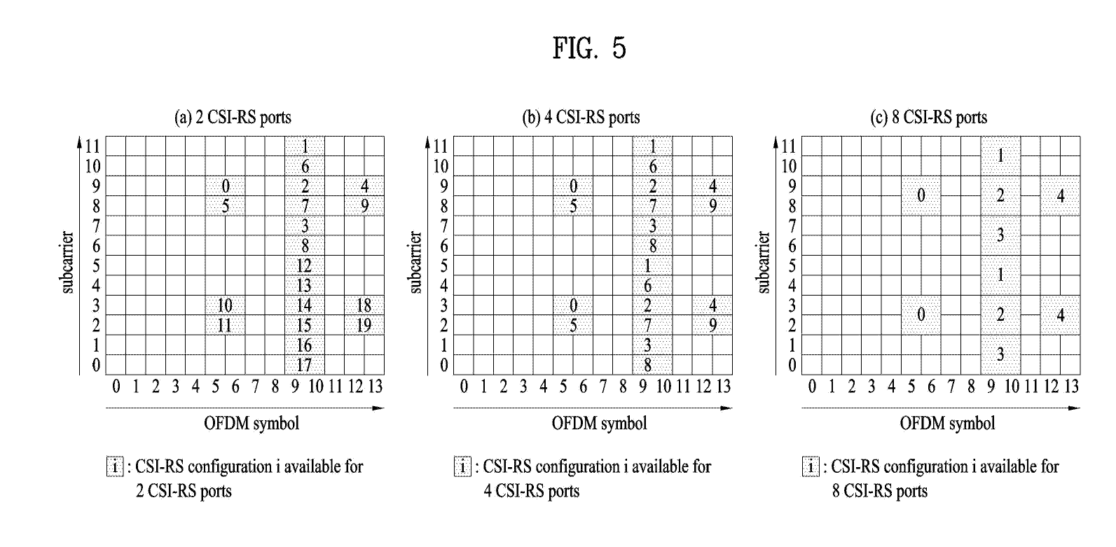

FIG. 5 illustrates CSI-RS mapping patterns according to antenna ports. An antenna port for CSI-RS transmission is referred to as a CSI-RS port and positions of resources in a predetermined resource region, in which CSI-RSs are transmitted through CSI-RS ports corresponding thereto, are referred to as a CSI-RS pattern or CSI-RS resource configuration. In addition, a time-frequency resource to/through which a CSI-RS is allocated/transmitted is referred to as a CSI-RS resource. For example, a resource element (RE) used for CSI-RS transmission is referred to as a CSI-RS RE. While the position of an RE through which a CRS is transmitted per antenna port is fixed, the CSI-RS has a maximum of 32 different configurations in order to reduce inter-cell interference (ICI) in a multi-cell environment including a heterogeneous network environment. A CSI-RS configuration depends on the number of antenna ports in a cell and CSI-RS configurations are set such that neighboring cells have different configurations. The CSI-RS supports up to 8 antenna ports (p=15, p=15,16, p=15, . . . , 18 and p=15, . . . , 22), distinguished from the CRS, and is defined for Δf=15 kHz only. Antenna ports p=15, . . . , 22 may respectively correspond to CSI-RS ports p=0, . . . , 7 in the following description.

Tables 5 and 6 show CSI-RS configurations that can be used in a frame structure (referred to as FS-1 hereinafter) for FDD (frequency division duplex) and a frame structure (referred to as FS-2 hereinafter) for TDD (time division duplex). Particularly, Table 5 shows CSI-RS configurations in a subframe having the normal CP and Table 6 shows CSI-RS configurations in a subframe having the extended CP.

TABLE 5

| | CSI-RS | Number of CSI-RSs configured | | | | | |
|---|---|---|---|---|---|---|---|
| | configu- | 1 or 2 | | 4 | | 8 | |
| | ration | (k′, l′) | nₛmod2 | (k′, l′) | nₛmod2 | (k′, l′) | nₛmod2 |
| FS-1 | 0 | (9, 5) | 0 | (9, 5) | 0 | (9, 5) | 0 |
| and | 1 | (11, 2) | 1 | (11, 2) | 1 | (11, 2) | 1 |
| FS-2 | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| FS-2 | 20 | (11, 1) | 1 | (11, 1) | 1 | (11, 1) | 1 |
| only | 21 | (9, 1) | 1 | (9, 1) | 1 | (9, 1) | 1 |
| | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

TABLE 6

| | CSI-RS | Number of CSI-RSs configured | | | | | |
|---|---|---|---|---|---|---|---|
| | configu- | 1 or 2 | | 4 | | 8 | |
| | ration | (k′, l′) | nₛmod2 | (k′, l′) | nₛmod2 | (k′, l′) | nₛmod2 |
| FS-1 | 0 | (11, 4) | 0 | (11, 4) | 0 | (11, 4) | 0 |
| and | 1 | (9, 4) | 0 | (9, 4) | 0 | (9, 4) | 0 |
| FS-2 | 2 | (10, 4) | 1 | (10, 4) | 1 | (10, 4) | 1 |
| | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| | 16 | (11, 1) | 1 | (11, 1) | 1 | (11, 1) | 1 |
| | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| FS-2 | 20 | (4, 1) | 1 | (4, 1) | 1 | | |
| only | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

When (k′, l′) (k′ being a subcarrier index in a resource block and l′ being an OFDM symbol index in a slot) in Tables 5 and 6 and ns (ns being a slot index in a frame) are applied to the following equation, a time-frequency resource used by each CSI-RS port to transmit a corresponding CSI-RS can be determined. That is, a CSI-RS sequence may be mapped to complex-valued modulation symbols used as reference symbols for CSI-RS port p in slot ns in a subframe (CSI-RS subframe) configured for CSI-RS transmission according to the following equation.

q_{k,l}^{(p)}=w_{l″}·r_{l,n}_{ₛ}(m′) [Equation 1]

In Equation 1, a resource index pair (k, l) (k being a subcarrier index and l being an OFDM symbol index in a subframe) used for CSI-RS port p for CSI-RS transmission can be determined according to the following equation.

$$k = {k}^{′} + 12 m + \{ \begin{matrix}- 0 & for p ∈ \{ 0 , 1 \} , normal cyclic prefix \\ - 6 & for p ∈ \{ 2 , 3 \} , normal cyclic prefix \\ - 1 & for p ∈ \{ 4 , 5 \} , normal cyclic prefix \\ - 7 & for p ∈ \{ 6 , 7 \} , normal cyclic prefix \\ - 0 & for p ∈ \{ 0 , 1 \} , extended cyclic prefix \\ - 3 & for p ∈ \{ 2 , 3 \} , extended cyclic prefix \\ - 6 & for p ∈ \{ 4 , 5 \} , extended cyclic prefix \\ - 9 & for p ∈ \{ 6 , 7 \} , extended cyclic prefix\end{matrix} \\ l = {l}^{′} + \{ \begin{matrix}{l}^{″} & CSI referencesignal configurations 0 - 19 , normal cyclic prefix \\ 2 {l}^{″} & CSI referencesignal configurations 20 - 31 , normal cyclic prefix \\ {l}^{″} & CSI referencesignal configurations 0 - 27 , extended cyclic prefix\end{matrix} \\ {w}_{{l}^{′}} = \{ \begin{matrix}1 & p ∈ \{ 0 , 1 , 2 , 3 \} \\ {( - 1 )}^{{l}^{″}} & p ∈ \{ 4 , 5 , 6 , 7 \}\end{matrix} \\ {l}^{″} = 0 , 1 \\ m = 0 , 1 , … , {N}_{RB}^{DL} - 1 \\ {m}^{′} = m + ⌊ \frac{{N}_{RB}^{max , DL} - {N}_{RB}^{DL}}{2} ⌋ \qquad [ Equation 2 ]$$

FIG. 5 illustrates CSI-RS configurations. Particularly, FIG. 5 illustrates CSI-RS configurations according to Equation 1 and Table 5 and shows positions of resources occupied by CSI-RSs in one RB pair in each CSI-RS configuration.

FIG. 5(a) shows 20 CSI-RS configurations available for CSI-RS transmission through 2 CSI-RS ports, FIG. 5(b) shows 10 CSI-RS configurations available for CSI-RS transmission through 4 CSI-RS ports and FIG. 5(c) shows 5 CSI-RS configurations available for CSI-RS transmission through 8 CSI-RS ports. CSI-RS configurations defined on the basis of the number of CSI-RS ports may be numbered.

When a BS sets 2 antenna ports for CSI-RS transmission, that is, sets 2 CSI-RS ports, CSI-RS transmission is performed in a radio resource corresponding to one of the 20 CSI-RS configurations, shown in FIG. 5(a), through the 2 CSI-RS ports. When 4 CSI-RS ports are set for a specific cell, CSI-RSs are transmitted in resources corresponding to CSI-RS configurations for the specific cell from among the 10 CSI-RS configurations, shown in FIG. 5(b), through the 4 CSI-RS ports. When 8 CSI-RS ports are set for the specific cell, CSI-RSs are transmitted in resources corresponding to CSI-RS configurations for the specific cell from among the 5 CSI-RS configurations, shown in FIG. 5(c), through the 8 CSI-RS ports.

CSI-RS configurations have a nested property. The nested property means that a CSI-RS configuration for a large number of CSI-RS ports becomes a super set of a CSI-RS configuration for a small number of CSI-RS ports. Referring to FIGS. 5(b) and 5(c), REs corresponding to CSI-RS configuration 0 with respect to 4 CSI-RS ports are included in resources corresponding to CSI-RS configuration 0 with respect to 8 CSI-RS ports.

A plurality of CSI-RSs may be used in a predetermined cell. In case of a non-zero power CSI-RS, only a CSI-RS with respect to one CSI-RS configuration is transmitted. In case of a zero power CSI-RS, a CSI-RS with respect to a plurality of CSI-RS configurations may be transmitted. A UE assumes zero transmission power for resources other than resources that need to be assumed to correspond to non-zero power CSI-RSs, from among resources corresponding to zero power CSI-RSs. For example, with regard to a radio frame for TDD, a CSI-RS is not transmitted in a special subframe in which downlink transmission and uplink transmission coexist, a subframe in which a paging message is transmitted and a subframe in which transmission of a synchronization signal, a physical broadcast channel (PBCH) or system information block type 1 (SIB1) collide with a CSI-RS, and the UE assumes that a CSI-RS is not transmitted in these subframes. A time-frequency resource used for a CSI-RS port to transmit the corresponding CSI-RS is not used for PDSCH transmission through any antenna port and is not used for CSI-RS transmission through an antenna port other than the corresponding CSI-RS port.

Since time-frequency resources used for CSI-RS transmission cannot be used for data transmission, data throughput decreases as CSI-RS overhead increases. In view of this, a CSI-RS is configured to be transmitted at a predetermined transmission interval corresponding to a plurality of subframes rather than being configured to be transmitted per subframe. In this case, CSI-RS transmission overhead can be remarkably reduced compared to a case in which the CSI-RS is transmitted per subframe. In the following description, a subframe configured for CSI-RS transmission is referred to as a CSI-RS subframe. A subframe configured for CSI-RS transmission may be defined by CSI-RS transmission periodicity and subframe offset. The CSI-RS transmission periodicity and subframe offset are referred to as a CSI-RS subframe configuration. Table 5 shows CSI-RS transmission periodicity I_{CSI-RS} and subframe offset Δ_{CSI-RS}.

TABLE 7

| CSI-RS subframe | CSI-RS periodicity | CSI-RS subframe offset |
|---|---|---|
| configuration I_{CSI-RS} | T_{CSI-RS} (subframes) | Δ_{CSI-RS} (subframes) |
| I_{CSI-RS≦4} | 5 | I_{CSI-RS} |
| 5 ≦ I_{CSI-RS≦14} | 10 | I_{CSI-RS-5} |
| 15 ≦ I_{CSI-RS≦34} | 20 | I_{CSI-RS-15} |
| 35 ≦ I_{CSI-RS≦74} | 40 | I_{CSI-RS-35} |
| 75 ≦ I_{CSI-RS≦154} | 80 | I_{CSI-RS-75} |

In Table 7, I_{CSI-RS} specifies CSI-RS transmission periodicity and subframe offset.

The BS may determine or adjust I_{CSI-RS} and transmit I_{CSI-RS} to UEs within the coverage of the corresponding cell. A UE may be aware of a CSI-RS subframe in which a CSI-RS of the cell (referred to as a serving cell, hereinafter) that provides communication services to the UE is transmitted on the basis of I_{CSI-RS}. The UE may determine a subframe which satisfies the following equation as a CSI-RS subframe.

(10n_{f}+└nₛ/2┘┘−Δ_{CSI-RS})mod T_{CSI-RS}=0 [Equation 3]

Here, n_{f} denotes a system frame number and nₛ represents a slot number of a radio frame.

For example, referring to Table 7, when I_{CSI-RS} is greater than 5 and less than 14, a CSI-RS is transmitted every 10 subframes, starting from a subframe corresponding to a subframe number I_{CSI-RS}-5.

The BS may notify the UE of the following parameters through higher layer signaling (e.g. medium access control (MAC) signaling or radio resource control (RRC) signaling).
Number of CSI-RS ports
CSI-RS configuration (refer to Tables 5 and 6, for example)
CSI-RS subframe configuration (refer to Table 7, for example)
CSI-RS subframe configuration periodicity T_{CSI-RS}
CSI-RS subframe offset Δ_{CSI-RS}

The BS may notify the UE of a CSI-RS configuration transmitted with zero power and a subframe configuration for transmission of a zero power CSI-RS as necessary. The CSI-RS configurations of Tables 5 and 6 may be used as the zero power CSI-RS configuration and the CSI-RS subframe configuration of Table 7 may be used as the subframe configuration for transmission of the zero power CSI-RS.

Channel State Information-Interference Measurement (CSI-IM)

CSI-IM uses part of resources configured as a zero-power CSI-RS, notifies a UE of the position of a CSI-IM resources corresponding to part of the zero-power CSI-RS resources and enables the UE to measure interference at the position.

In transmission mode 10, one or more higher layers can configure one or more CSI processes per serving cell for the UE. Each CSI process is associated with a CSI-RS resource and a CSI-IM resource. CSI reported by the UE corresponds to a CSI process configured by the higher layers and each CSI process can be configured with a PMI/RI or without a PMI/RI through higher layer scheduling.

[CSI-RS Resource]

As to a serving cell and a UE configured in transmission mode 10, the UE can be assigned one or more CIS-RS resource configurations. The following parameters for which the UE needs to assume non-zero transmit power for CSI-RS are configured per CSI-RS resource configuration through higher layer signaling.
CSI-RS resource configuration identifier
The number of CSI-RS ports
CSI-RS subframe configuration I_{CSI-RS}
UE assumption for power Pc transmitted through a reference PDSCH for CSI feedback per CSI process. If CSI subframe sets CCSI 0 and CCSI 1 are configured by higher layers for a CSI process, Pc is set for each CSI subframe set of the CSI process.
Pseudo-random sequence generation parameter n_{ID}
UE assumption with respect to quasi co-location (QCL) type B of CRS antenna ports and CSI-RS antenna ports using the following parameters
Cell ID for a QCL-assumed CRS
The number of CRS antenna ports for the QCL-assumed CRS
MBSFN subframe configuration for the QCL-assumed CRS

[CSI-IM Resource]

As to a serving cell and a UE configured in transmission mode 10, one or more CSI-IM resource configurations can be configured for the UE. The following parameters are set per CSI-IM resource configuration through higher layer signaling.
Zero-power CSI-RS configuration
Zero-power CSI-RS subframe configuration I_{CSI-RS}

The UE does not receive CSI-IM resource configurations that do not completely overlap with one zero-power CSI-RS resource configuration that can be configured for the UE. In addition, the UE does not receive a CSI-IM resource configuration that does not completely overlap with one of the zero-power CSI-RS resource configurations.

[Zero-Power CSI-RS Resource]

As to a serving cell and a UE configured in transmission mode 10, one or more zero-power CSI-RS resource configurations can be configured for the UE. The following parameters are set through higher layer signaling for one or more zero-power CSI-RS resource configurations.
Zero-power CSI-RS configuration list (16-bit bitmap)
Zero-power CSI-RS subframe configuration I_{CSI-RS}

CoMP (Coordinated Multiple Point Transmission and Reception)

In accordance with the improved system throughput requirements of the 3GPP LTE-A system, CoMP transmission/reception technology (also referred to as Co-MIMO, collaborative MIMO or network MIMO) has recently been proposed. The CoMP technology can increase throughput of a UE located at a cell edge and also increase average sector throughput.

In general, in a multi-cell environment in which a frequency reuse factor is 1, the performance of the UE located on the cell edge and average sector throughput may be reduced due to Inter-Cell Interference (ICI). In order to reduce the ICI, in the legacy LTE system, a method of enabling the UE located at the cell edge to have appropriate throughput and performance using a simple passive method such as Fractional Frequency Reuse (FFR) through the UE-specific power control in the environment restricted by interference is applied. However, rather than decreasing the use of frequency resources per cell, it is preferable that the ICI is reduced or the UE reuses the ICI as a desired signal. In order to accomplish the above object, a CoMP transmission scheme may be applied.

The CoMP scheme applicable to the downlink may be largely classified into a Joint Processing (JP) scheme and a Coordinated Scheduling/Beamforming (CS/CB) scheme.

In the JP scheme, each point (eNB) of a CoMP unit may use data. The CoMP unit refers to a set of eNBs used in the CoMP scheme. The JP scheme may be classified into a joint transmission scheme and a dynamic cell selection scheme.

The joint transmission scheme refers to a scheme for transmitting a PDSCH from a plurality of points (a part or the whole of the CoMP unit). That is, data transmitted to a single UE may be simultaneously transmitted from a plurality of transmission points. According to the joint transmission scheme, it is possible to coherently or non-coherently improve the quality of the received signals and to actively eliminate interference with another UE.

The dynamic cell selection scheme refers to a scheme for transmitting a PDSCH from one point (of the CoMP unit). That is, data transmitted to a single UE at a specific time is transmitted from one point and the other points in the cooperative unit at that time do not transmit data to the UE. The point for transmitting the data to the UE may be dynamically selected.

According to the CS/CB scheme, the CoMP units may cooperatively perform beamforming of data transmission to a single UE. Although only a serving cell transmits the data, user scheduling/beamforming may be determined by coordination of the cells of the CoMP unit.

In uplink, coordinated multi-point reception refers to reception of a signal transmitted by coordination of a plurality of geographically separated points. The CoMP scheme applicable to the uplink may be classified into Joint Reception (JR) and Coordinated Scheduling/Beamforming (CS/CB).

The JR scheme indicates that a plurality of reception points receives a signal transmitted through a PUSCH, the CS/CB scheme indicates that only one point receives a PUSCH, and user scheduling/beamforming is determined by the coordination of the cells of the CoMP unit.

In addition, one case in which there are multiple UL points (i.e., multiple Rx points) is referred to as UL CoMP, and the other case in which there are multiple DL points (i.e., multiple Tx points) is referred to as DL CoMP.

HARQ Process

In the LTE FDD system, eight Stop-And-Wait (SAW) HARQ processes are supported on both the uplink and the downlink in accordance with a constant round-trip time (RTT) of 8 ms.

The respective HARQ processes are defined by a unique HARQ process identifier of 3 bit size, and individual soft buffer allocation for combination of retransmitted data is required for a reception end (that is, UE at the downlink HARQ process, and eNodeB at the uplink HARQ process). Also, in the LTE system, it is defined that information such as a new data indicator (NDI), a redundancy version (RV) and a modulation and coding scheme (MCS) level is signaled to the reception end.

In the meantime, the downlink HARQ process of the LTE system is an adaptive asynchronous scheme. Accordingly, downlink control information for the HARQ process is explicitly accompanied per downlink transmission. On the other hand, the uplink HARQ process of the LTE system is a synchronous scheme, and may be performed adaptively or non-adaptively. Since the uplink non-adaptive HARQ scheme does not accompany signaling of explicit control information, sequence such as previously set RV sequence, that is, 0, 2, 3, 1, 0, 2, 3, 1, . . . is required for continuous packet transmission. However, according to the uplink adaptive HARQ scheme, RV is signaled explicitly.

Enhanced-PDCCH (EPDCCH)

The LTE system after release 11 considers an enhanced PDCCH (EPDCCH) that may be transmitted through a conventional PDSCH region, as a solution of PDCCH capacity shortage caused by Coordinate Multi Point (CoMP), Multi User-Multiple Input Multiple Output (MU-MIMO), etc. and PDCCH throughput reduction caused by inter-cell interference. Also, unlike conventional CRS based PDCCH, DMRS based channel estimation may be performed for the EPDCCH to obtain precoding gain.

EPDCCH transmission may be divided into localized EPDCCH transmission and distributed EPDCCH transmission depending on configuration of PRB (Physical Resource Block) pair used for EPDCCH transmission. The localized EPDCCH transmission means that ECCEs used for one DCI transmission are adjacent to one another in a frequency domain, and specific precoding may be applied to the localized EPDCCH transmission to obtain beamforming gain. For example, the localized EPDCCH transmission may be based on continuous ECCEs corresponding to an aggregation level. On the other hand, the distributed EPDCCH transmission means that one EPDCCH is transmitted from PRB pair spaced apart from the frequency domain, and has gain in view of frequency diversity. For example, the distributed EPDCCH transmission may be based on ECCE comprised of four EREGs included in each PRB pair spaced apart from the frequency domain.

The user equipment may perform blind decoding similarly to the existing LTE/LTE-A system to receive and acquire downlink control information (DCI) through the EPDCCH. In more detail, the user equipment may attempt (monitor) decoding for a set of EPDCCH candidates per aggregation level for DCI formats corresponding to a set transmission mode. In this case, the set of the EPDCCH candidates for monitoring may be referred to as EPDCCH UE-specific search space, which may be set/configured per aggregation level. Also, the aggregation level of {1, 2, 4, 8, 16, 32} may be configured in accordance with subframe type, CP length, available resource amount within the PRB pair, etc. differently from the existing LTE/LTE-A system.

The user equipment configured by the EPDCCH may index REs included in the PRB pair set to EREG and again index the EREG to ECCE unit. The user equipment may determine EPDCCH candidates, which constitute the search space, on the basis of the indexed ECCE and perform blind decoding, thereby receiving control information. In this case, the EREG is a concept corresponding to REG of the existing LTE/LTE-A system, and the ECCE is a concept corresponding to CCE. 16 EREGs may be included in one PRB pair.

In addition, for each serving cell, one UE may configure one or two EPDCCH PRB sets for PDCCH monitoring through higher layer signaling.

In 3GPP LTE Rel-11, a UE, to which a CoMP scheme is applied, may estimate channels of TPs, which may potentially participate in CoMP, using channel state information-reference signal (CSI-RS) resources defined as a CoMP measurement set and feed CSI such as a precoding matrix indicator (PMI), a channel quality indicator (CQI) or a rank indicator (RI) back to its serving cell on the basis of the estimated channel values. A network may configure a dynamic point selection (DPS) scheme for selecting a TP having relatively excellent channel quality based on the fed-back CSI information to enable the UE to perform data transmission, a coordinated scheduling/coordinated beamforming (CS/CB) scheme for, at TPs participating in CoMP, controlling scheduling and beamforming to reduce mutual interference and a joint transmission (JT) scheme for, at TPs participating in CoMP, transmitting the same data to the UE.

If the TPs perform CoMP operation through a non-ideal backhaul, a real-time CoMP structure is not operated due to backhaul delay unlike the existing ideal backhaul, whereby this specification suggests a network structure and a CoMP structure, which are suitable for the non-ideal backhaul.

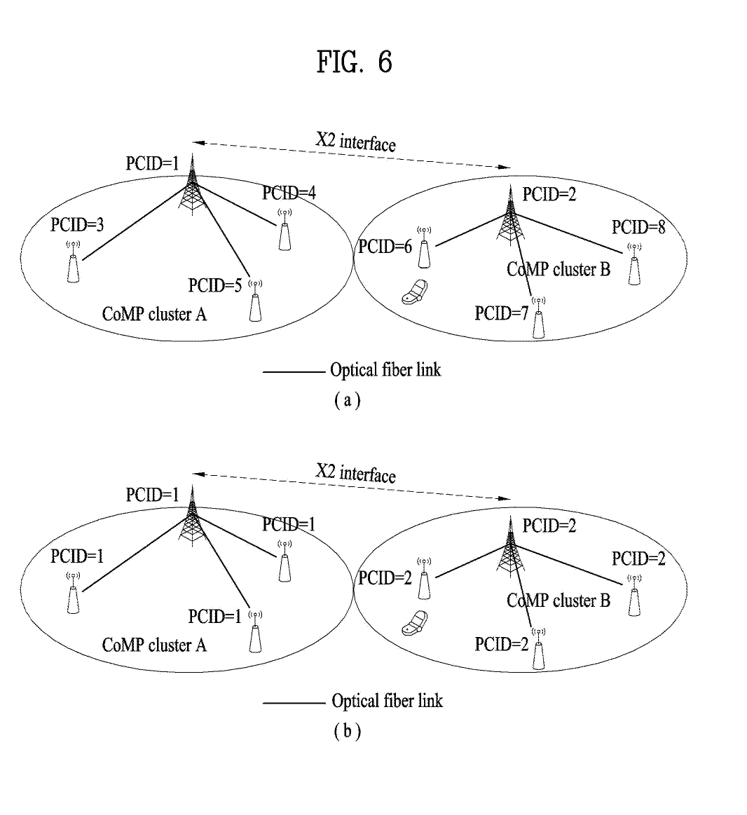

Hereinafter, a CoMP cluster will be described. A CoMP cluster is a set of cells that are capable of performing the CoMP operations, i.e., cooperative scheduling and cooperative data transmission/reception, in accordance with mutual cooperation. For example, cells of a single cluster may be assigned with different physical cell IDs (PCIDs) as shown in FIG. 6(a), or cells of a single cluster may share the same PCIDs such that the cells may be configured in the form of a distributed antenna or RRH of a single eNB as shown in FIG. 6(b). In modified examples of FIG. 6, some cells from among cells of the single cluster may share the same PCIDs.

Generally, cells of the same CoMP cluster are interconnected through a backhaul link, such as an optical fiber having high capacity and low latency, so as to implement cooperative scheduling and cooperative data transmission/reception, such that the cooperative scheduling is possible, and are maintained at a correct time synchronization state, resulting in implementation of cooperative data transmission. In addition, when receiving signals from cells of the CoMP cluster participating in the cooperative data transmission, the size of CoMP cluster must be determined in a manner that a reception time difference between signals transmitted from respective cells may enter the scope of a cyclic prefix (CP) length of OFDM symbol on the basis of a propagation delay difference between respective cells. In contrast, cells belonging to different clusters may be interconnected through a lower-capacity backhaul link, and may not maintain time synchronization.

A UE configured to perform CoMP may perform cooperative scheduling and cooperative data transmission/reception by some or all of cells contained in the CoMP cluster, and the UE may measure a reference signal that is transmitted from some or all cells of the CoMP cluster in accordance with a UE reception signal quality. In order to measure link performances of UE and each cell, the UE may measure a reference signal of each cell and may report reception signal quality of the measured reference signal. Specifically, cells to be measured by the UE may be defined as a CoMP measurement set.

However, this specification is intended to suggest a scenario for performing CoMP between TPs interconnected through a non-ideal backhaul that may cause delay between the TPs.

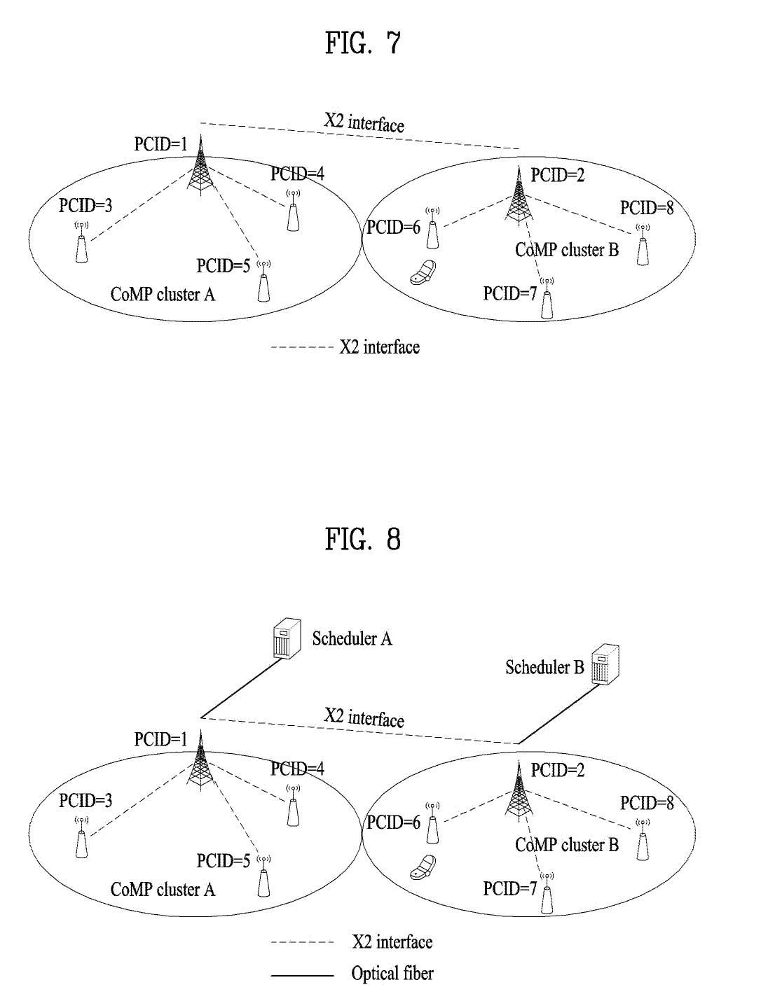

FIG. 7 illustrates a scenario that TPs in a CoMP cluster are interconnected through X2 interface. There are a higher TP for controlling each TP and representative TPs (TP of PCID=1 in CoMP cluster A, and TP of PCID=1 in CoMP cluster B) having a function of a scheduler, etc. in a CoMP cluster A and a CoMP cluster B, wherein the representative TPs and each TP may perform communication through the X2 interface. The respective representative TPs may perform mutual communication through the X2 interface. It is assumed that the respective TPs are interconnected through the X2 interface although not shown in the accompanying drawing of this specification.

On the other hand, entities, i.e., schedulers A and B, which have a function of controlling and scheduling lower TPs, may exist in the representative TP separately from the base station as shown in FIG. 8. In FIG. 8, the scheduler A serves to control and schedule the TPs and UEs, which belong to the CoMP cluster A, and the scheduler B serves to control and schedule the TPs and UEs, which belong to the CoMP cluster B. Information for each TP is transferred to the TPs having PCID 1 and PCID 2, which correspond to the representative TPs, through the X2 interface, and processing and scheduling of every information are determined by the scheduler connected with the representative TP.

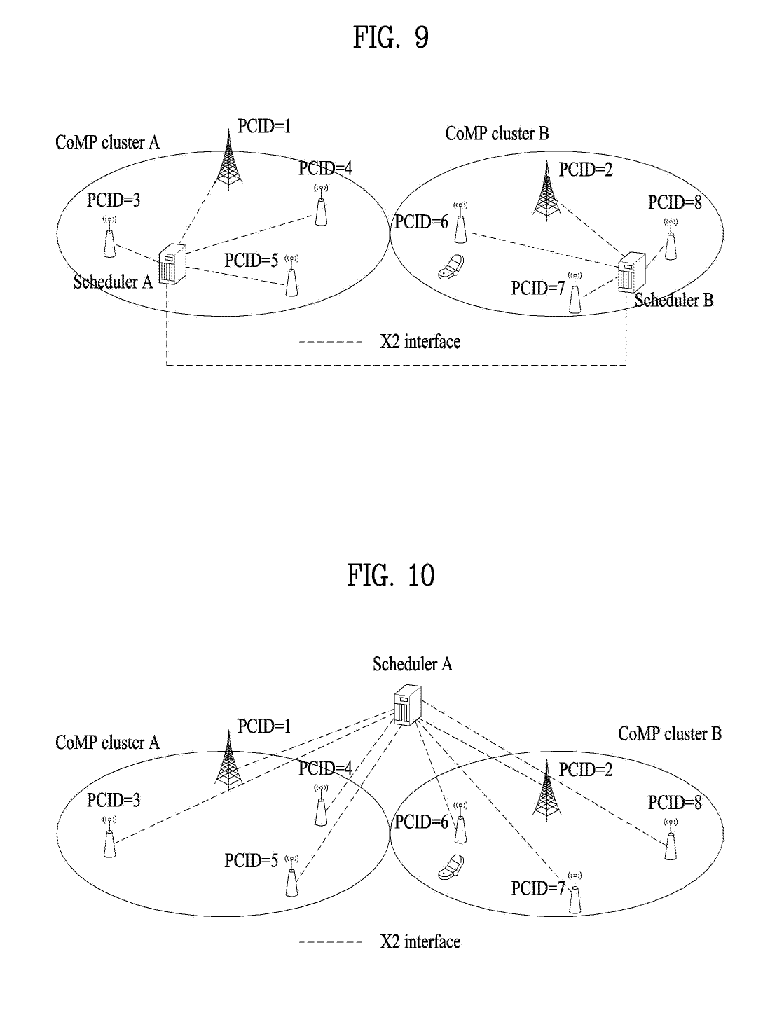

Another network structure that performs CoMP operation through a non-ideal backhaul is shown in FIG. 9. Information to be transmitted/received from each TP without a concept of a representative TP is collected to the scheduler that serves to control each CoMP cluster, and the scheduler serves to transfer a control, scheduling and important command of each TP by using the received information. The schedulers of the respective CoMP clusters may also be interconnected through the X2 interface. As another embodiment, for data intensive processing, the schedulers of the respective CoMP clusters may be interconnected through a real-time transmission medium such as an optical fiber.

As still another embodiment, one scheduler may perform a function of scheduling and controlling a plurality of CoMP clusters as shown in FIG. 10.

How the representative TP or the scheduler controls and schedules each TP will be described based on the aforementioned network structure described with reference to the accompanying drawings. In more detail, how the representative TP or the scheduler enables DL CoMP operation will be suggested. For convenience of description, the representative TP and the scheduler will now be referred to as a “scheduler”.

### First Embodiment

### CoMP Measurement Set Determination

Cell-specific information that needs to be exchanged between cells (or TPs) in order to determine a CoMP cluster for fundamental X2-based DL CoMP is as follows. The cell-specific information needs to be exchanged before the corresponding cells perform CoMP.
Cell identification information
(Cell-specific) non-zero power CSI-RS configuration
CRS information for PDSCH rate-matching: a cell identifier, a CRS port number, and an MBSFN configuration
(Cell-specific) CSI-IM resource configuration: a CSI-IM index, a CSI-IM resource position, and a subframe in which a CSI-IM resource is disposed
CSI-process information: combination of a non-zero power CSI-RS resource and a CSI-IM resource

Each TP configures a combination of TPs for CoMP per UE on the basis of long-term channel measurement reported by each UE for neighboring TPs. For the purpose of configuring a CoMP cluster, a TP determines a CoMP measurement set for short-term channel measurement of each UE for CoMP and transmits the CoMP measurement set to the corresponding UE on the basis of information of other TPs received therefrom. Here, the CoMP measurement set can be represented as a set of reference signals that need to be measured/reported by individual UEs for CoMP. For example, the CoMP measurement set can be configured as a set of combinations of a non-zero CSI-RS and CSI-IM. A description will be given of an embodiment of the present invention depending on whether a centralized scheduler is present in the CoMP cluster.

1.1 Case in which Centralized Scheduler is Present

When a centralized scheduler that controls a plurality of cells (or TPs) is present, the scheduler knows information such as positions of cells and the like. Each cell can report the following cell-specific information necessary for CoMP to the scheduler.

Cell_specific_CoMP information {NZP CSI-RS configuration, CSI-IM configuration, CSI-process identifier, cell identifier, CRS port number, MBSFN configuration}

The scheduler can determine a CoMP management set on the basis of the cell_specific_CoMP information received from each cell and known information about the position of each cell. Then, the scheduler can notify the corresponding cells of the CoMP management set. Here, the CoMP management set refers to a set of a plurality of CSI-RSs. A cell that has received the CoMP management set can configure a plurality of CSI-RSs (i.e., CoMP management set) for UEs served thereby and request the UEs to report long-term measurement values for the CSI-RSs. The UEs can calculate receive power for the CSI-RSs and report the calculated receive power to the serving cell.

In addition, the serving cell or a network can designate additional CIS-IM resources for long-term measurement for CSI-RSs belonging to the CoMP management set and designate a CSI-IM resource for long-term measurement for each CSI-RS belonging to the CoMP management set. In this case, a UE can use the corresponding CSI-RS for signal measurement with respect to each CSI-RS and use the designated CSI-IM resource for interference measurement. Here, the designated CSI-IM resources may be resources commonly applied to the CSI-RSs belonging to the CoMP management set. The CSI-IM resources for long-term measurement of the CSI-RSs may be designated by the scheduler.

Each cell can select a cell with which CoMP will be performed on the basis of long-term CSI-RS measurement reports received from UEs. Such values received from the UEs can be transmitted to the scheduler such that the scheduler selects and determines cells which perform CoMP.

Alternatively, a cell may determine CoMP cells and allow the scheduler to finally decide a cell with which the corresponding cell will perform CoMP. Specifically, the cell may determine cells having good channel states with respect to a specific UE as CoMP candidate cells and transmit, to the scheduler, a candidate list including cells having CSI-RS configurations corresponding to reported satisfactory CSI-RS measurement values. Upon reception of such information from a plurality of cells, the scheduler can determine a set of cells which will perform CoMP, that is, a CoMP cluster on the basis of received candidate lists. Here, the scheduler transmits information about the CoMP cluster to the cells which will cooperate in CoMP. The information about the CoMP cluster includes the following information.

Information about the CoMP Cluster {List of Cell Identifiers, CSI-RS Configurations Corresponding Thereto and CSI-IM Configurations}

In addition, the information about the CoMP cluster may include information about time when actual CoMP operation is started. Such time information can be represented as a time after a specific system frame number (SFN) or N specific radio frames/subframes.

The information about the CoMP cluster can be understood by a UE as a CoMP measurement set and the serving cell can configure the CoMP measurement set corresponding to a set of CSI-RS information for the UE.

1.2 Case in which Centralized Scheduler is not Present

When a centralized scheduler is not present, the aforementioned information is freely exchanged between cells (or TPs) through an interface. During determination of CoMP, the information is exchanged through request and acknowledgement procedures for CoMP operation between cells. That is, the cells transmit cell_specific_CoMP_information to other cells. Cell_specific_CoMP_information includes the aforementioned information.

Cell_Specific_CoMP_Information {NZP CSI-RS Configuration, CSI-IM Configuration, Cell Identifier, CRS Port Number and MBSFN Configuration}

Upon reception of such information from a plurality of cells, a cell can determine a CoMP management set as a super set of a CoMP measurement set in order to decide the CoMP measurement set. The cell configures a plurality of CSI-RSs for a UE. In this case, the plurality of CSI-RSs can be defined as the CoMP management set. The cell can request the UE to report a long-term measurement value for the CoMP management set. The UE can calculate receive power for the plurality of CSI-RSs at the request of the cell and report the receive power to the cell.

In addition, the serving cell or the network can designate additional CSI-IM resources for long-term measurement for CSI-RSs belonging to the CoMP management set and designate a CSI-RS resource for long-term measurement per CSI-RS belonging to the CoMP management set. Here, the designated CSI-IM resources may be resources commonly applied to the CSI-RSs belonging to the CoMP management set. In this case, the UE can use the corresponding CSI-RS for signal measurement for each CSI-RS and use the designated CSI-IM resources for interference measurement.

The cell can select a cell with which CoMP will be performed on the basis of a long-term measurement report received from the UE. The cell can determine a cell having a good channel state with respect to a specific UE as a CoMP candidate cell and transmit CoMP_operation_request to a cell (i.e. CoMP candidate cell) having a CSI-RS configuration corresponding to a satisfactory long-term measurement report. The CoMP_operation_request may include the long-term measurement report received by the cell from the UE. In addition, the CoMP_operation_request may include information about time when actual CoMP operation is started. Such time information may be represented as a time after a specific SFN or N specific radio frames/subframes.

The CoMP candidate cell can transmit CoMP_operation_acknowledgement to the cell and thus the two cells can make an appointment for start of the CoMP operation for the UE. Information indicating rejection of the CoMP_operation_request may be included in the CoMP_operation_acknowledgement such that CoMP of the two cells is not performed.

Upon determination of CoMP operation between the two cells, the cells can configure a CoMP cluster. The CoMP cluster refers to cells which will cooperate and information about the CoMP cluster may include the following information.

Information about the CoMP Set {List of Cell Identifiers, CSI-RS Configurations Corresponding Thereto and CSI-IM Configurations}

Based on the CoMP cluster, each serving cell can configure a CoMP measurement set for the UE. The CoMP measurement set can be represented as a set of CSI-RS information.

In DL CoMP, the UE receives most control signals from the serving cell. While a UL control signal of the UE may be received/demodulated by only the serving cell in the case of UL, it may be preferable that a cell (i.e. the other cell participating in CoMP operation) other than the serving cell receive the UL control signal of the UE. Accordingly, the cells participating in CoMP operation need to know information about a control channel of the UE in advance. Particularly, the cells need to know information about which CSI-RS and which CSI-IM are combined for a CSI process of the UE. Configuration information such as the position of a transmission resource and a transmission period of UL control information of the UE depends on a CSI process identifier of each cell. Such information can be shared by all cells participating in CoMP through the information about the CoMP cluster.

### Second Embodiment

### PDSCH Scheduling

In the second embodiment of the present invention, a procedure and signaling for a CoMP scheme and PDSCH scheduling available depending on network structure (whether the aforementioned centralized scheduler is present) are proposed.

Whether cooperating TPs share transmission data (PDSCH) to be provided to a specific UE (e.g., a CoMP scheme in which a plurality of TPs cooperate to transmit DL data in DL CoMP, e.g., joint transmission (JT)) is determined depending on a network structure and a CoMP scheme. In the case of CoMP using an X2 interface backhaul, an available CoMP scheme depends on backhaul latency. Backhauls may have three speeds, fast/medium/slow. A fast backhaul enables dynamic scheduling. Particularly, when latency of the fast backhaul is less than 1 ms, the corresponding backhaul can serve UEs with the same latency as that during single cell operation. In the case of medium and slow backhauls, quasi-static scheduling rather than dynamic scheduling is appropriate.

In the specification, a serving TP refers to a serving cell of a UE served through CoMP and a scheduler refers to an entity that performs CoMP related scheduling in a network structure including a centralized scheduler. While the scheduler may be a scheduler as an upper entity of TPs, as shown in FIG. 8, a representative TP may be present and an entity having functions of controlling and scheduling a corresponding TP and lower TPs in the representative TP may be present separately from the TPs, as shown in FIG. 7. In addition, the representative TP may be present in a CoMP cluster in a fixed manner, as shown in FIG. 7. When the representative TP is determined and changed dynamically or semi-statically in the network structure as shown in FIG. 7, the network structure can be understood as a network structure in which distributed scheduling is performed.

Furthermore, in the specification, a Co-TP refers to a TP other than the serving TP that serves UEs through CoMP and indicates a TP that directly participates in PDSCH scheduling or participates in interference mitigation, control information exchange and the like.

Embodiments of the present invention will now be described.

2.1 Case in which PDSCH is Transmitted Only from Serving Cell

A description will be given of a CoMP scheme in which a PDSCH is transmitted only by a serving cell rather than being shared by cooperating TPs and the serving cell performs, with the cooperating TP, only coordination with respect to a beamforming vector such that interference applied to a corresponding UE is minimized, that is, coordinated silencing/coordinated beamforming (CS/CB). Schemes applicable depending on network structures (a network structure in which a centralized scheduler is present (i.e., centralized scheduling) and other structures (i.e. distributed scheduling)) are arranged in the following table.

TABLE 8

| | Distributed |
|---|---|
| Centralized scheduler + CS/CB | scheduler + CS/CB |
| Transmit data from only serving TP | Transmit data from |
| No data/control sharing/exchange required | only serving TP |
| Needed information for cooperating TP: | Master-slave eNB or |
| scheduled PMI or best/worst companion PMI | anchor-sub eNB |
| Dynamic scheduling works well in | Semi-static master- |
| fast/medium speed of backhaul link | slave relation |
| Semi-static scheduling works in slow speed | Dynamic master-slave |
| of backhaul link | relation e.g. by |
| Master eNB with scheduler or another | coin tossing |
| scheduler entity | |

2.1.1 Centralized Scheduling+CS/CB Using Fast Backhaul Link

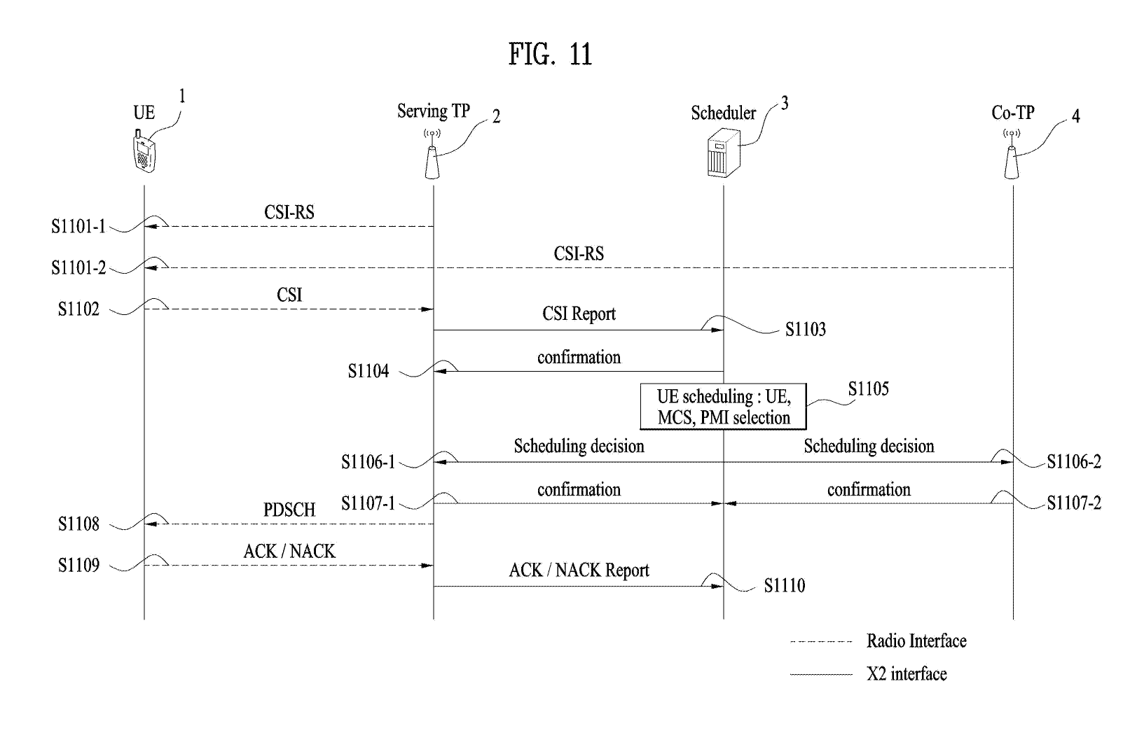

FIG. 11 illustrates a CoMP procedure when the centralized scheduler is present in a CoMP cluster and a fast backhaul is provided. A serving TP 2 and a Co-TP 4 can transmit CSI-RSs (S1101-1 and S1101-2). A UE 1 can receive/measure the CSI-RSs transmitted from the TPs and report channel state information (CSI) corresponding to the reception/measurement result, e.g., a channel quality indicator (CQI), a precoding matrix indicator (PMI), a rank indicator (RI) and a precoding type indicator (PTI), to the serving TP (S1102). The CSI-RSs from the TPs can be configured as the aforementioned CoMP measurement set by the serving TP or network. The serving TP can report the CSI received from the UE to a scheduler 3 (S1103). The scheduler can send signaling indicating successful reception of the CSI to the serving TP (S1104). FIG. 11 shows such signaling as “confirmation”. In the present embodiment, dynamic scheduling is possible and a PDSCH is not shared by the serving TP and the Co-TP. The scheduler can decide scheduling such as UE selection, modulation and coding scheme (MCS) selection and PMI selection (S1105) and deliver such scheduling decision to the serving TP (S1106-1). In addition, the scheduler can select a UE that needs to be served by the Co-TP and select an MCS and a PMI that need to be used by the selected UE on the basis of scheduling decision (S1105). Then, the scheduler can send the selected scheduling decision to the Co-TP (S1106-2). The serving TP and the Co-TP can signal “confirmation” to the scheduler as a response to the scheduling decision (S1107-1 and S1107-2).

Here, the PMI used by the UE served by the Co-TP is limited by a PMI used by the serving TP, and thus the PMI used by the UE needs to be selected as the best companion PMI or selected from PMIs other than the worst companion PMI. The best companion PMI refers to a PMI that minimizes interference with a downlink signal due to a PMI scheduled for the UE 1 and the worst companion PMI refers to a PMI that maximizes interference with a downlink signal due to the PMI scheduled for the UE 1. In the present embodiment, the serving TP notified of the scheduling decision transmits a PDSCH to the corresponding UE according to the scheduling decision (S1108), receives ACK/NACK for the PDSCH (S1109) and delivers the received ACK/NACK information to the scheduler 3 (S1110) so as to determine whether to perform retransmission.

2.1.2 Centralized Scheduling+CS/CB Using Non-Fast Backhaul Link

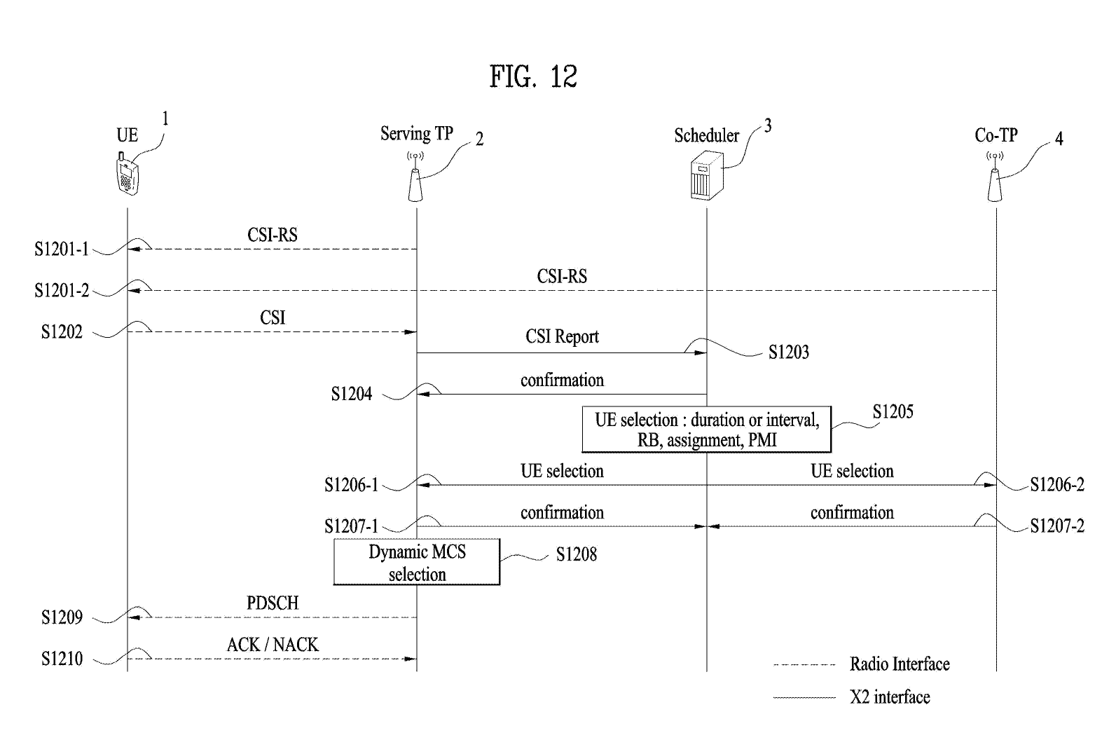

When a PDSCH is not shared between TPs in a CoMP cluster in which the centralized scheduler is present and the speed of the backhaul link is not fast (i.e., when the backhaul link is not a fast backhaul link), dynamic scheduling as shown in FIG. 7 is impossible. While fundamental CSI-RS measurement of a UE, CSI reporting for CSI-RS measurement and operation of the serving TP to transmit such information to the scheduler correspond to the embodiment related to FIG. 7, scheduling operation of the scheduler differs from the operation shown in FIG. 7. That is, S1201-1 to S1204 of FIG. 12 correspond to S1101-1 to S1104 of FIG. 11.

Scheduling operation of the scheduler may be divided into UE selection, MCS selection and PMI selection at specific timing. Since communication between TPs and between a TP and the scheduler is not performed in real time due to high latency of the backhaul link, message exchange between the TPs is preferably minimized. Accordingly, the scheduler can select a UE that will be scheduled in specific time and frequency regions (resource block (RB) regions) and determine a PMI at the corresponding timing (S1205). Then, the scheduler can transmit the determined information to the serving TP (S1206-1). The scheduler selects a specific UE in a specific duration, specific interval or specific time pattern and selects a PMI at the corresponding timing. Accordingly, the scheduler can deliver, to the serving TP, information on the selected UE and the PMI along with such time information, determine a UE to be served by the Co-TP and a PMI and send the determined UE and PMI to the Co-TP (S1206-2). Then, the serving TP and the Co-TP can select an MCS suitable for each PDSCH transmission timing on the basis of the information transmitted from the scheduler (S1208) and transmit a PDSCH on the basis of the selected MCS (S1209). Since the scheduler selects the UE in the specific duration or specific interval/pattern, PDSCH transmission and retransmission during the corresponding time are managed by the serving TP. Accordingly, UL ACK/NACK information for PDSCH transmission is transmitted to the serving cell instead of the scheduler (S1210).

2.1.3 Distributed Scheduling+CS/CB Using Non-Fast Backhaul Link

When cooperating TPs do not share data to be transmitted to a UE and only the serving cell transmits the data, real-time communication cannot be performed since the speed of the backhaul link is not high, a certain amount of latency is present, and a separate centralized scheduler is not present and TPs decide scheduling in a distributed manner in a network, hierarchy of TPs needs to be semi-statically formed. Since each TP attempts to transmit a PDSCH for a UE served thereby, it is necessary to determine a TP that will preferentially serve a UE corresponding thereto with priority and a time when the TP will serve the UE. In addition, the other TP needs to perform CS or CB in order not to apply interference to the served UE at the corresponding time. Accordingly, decision of priority of the TPs can be the most important part for successful CoMP between the TPs in this network structure.

Simply, priority for time resources can be separately determined through communication between the TPs. The time resources are represented by periods and offsets. A specific TP has scheduling priority at a time (specific subframe or specific radio frame) represented by a specific period and offset. Alternatively, a time in which a specific TP has priority can be determined in a specific time pattern (e.g., bitmap with respect to radio frames and subframes). For example, priority of TPs within an interval of N specific radio frames can be determined per subframe. If N=4, the TPs can exchange a 40-bit bitmap using an X2 interface through negotiation on time resources through the X2 interface.

Priority at/in a timing/interval can be determined in such a manner that the TPs generate random numbers and a TP having the largest random number at the corresponding timing/interval has priority. Alternatively, priority can be determined through coin tossing. In this case, information that needs to be preferentially exchanged during negotiation between the TPs can be a generated random number of a coin tossing result value. When the TPs exchange the 40-bit bitmap using the X2 interface through such negotiation, priority in the time resource region is determined and thus the TPs can perform scheduling in a distributed manner.

Similarly, priority of the TPs in the frequency resource region can be determined. The entire frequency can be divided into M arbitrary blocks and different TPs can have scheduling priority in the respective blocks. A method of determining priority of the TPs in each block may be similar to the aforementioned method of determining priority in the time resource region. In this case, each TP can generate a random number or perform coin tossing. A random number or a coin tossing result generated by each TP per block can be exchanged through the X2 interface and priority can be determined through this procedure.

The method for determining priority in the time resource region and the method for determining priority in the frequency resource region may be combined and used. When the two methods are combined, more efficient scheduling and resource utilization can be achieved. Since the speed of the backhaul link is not high, priority which has been determined once may be static or semi-static.

2.2 Case in which a PDSCH is Transmitted from Multiple Cells

The present embodiment relates to a CoMP scheme and a network structure in which a PDSCH is transmitted from a plurality of TPs. To transmit the same PDSCH by a plurality of TPs, cooperating TPs need to share data. Data sharing can be considered as two steps. As shown in the following table, data sharing can be divided into i) a case in which a TCP/IP packet is shared and ii) a case in which a transport block (TP) is shared.

TABLE 9

| | |
|---|---|
| TCP/IP packet sharing | The same TCP/IP packets are arrived at |
| | multiple TPs |
| | Transport block generation at multiple TPs |
| | ACK/NACK/CQI sharing required |
| | Packet segmentation information sharing |
| | required |
| | One TCP/IP packet is divided and used by |
| | two TPs |
| | Multi-flow: point selection, multiple TPs |
| | have different packets and thus respectively |
| | send the packets |
| Transport block sharing | All transport blocks arrived at serving TP |
| | Serving TP generates and segments a code |
| | block |
| | Code block sharing required |

TCP/IP packet sharing means that a TCP/IP packet for a specific UE arrives at a plurality of TPs. Each TP configures a transport block using the arrived TCP/IP packet and equally generates a code block for actual transmission. Here, the plurality of TPs needs to share packet segmentation information for the same TCP/IP packet.

According to another TCP/IP packet sharing method, one TCP/IP packet is segmented and respectively used by multiple TPs. For example, one TCP/IP packet can be segmented for multiple TPs in such a manner that some segments are transmitted by TP A and some segments are transmitted by TP B. In this case, however, when radio link protocol (RLP) retransmission occurs, it is difficult to process RLP retransmission and a higher layer may have difficulty in TCP/IP packet management.

According to another TCP/IP packet sharing method, multiple TPs have different TCP/IP packets and respectively send the TPC/IP packets to a specific UE according to point selection. That is, the multiple TPs do not share the same TCP/IP packet, a TCP/IP packet of each TP is a unique packet, and a TP takes charge of transmission of a TCP/IP packet having arrived thereat.

Transport block sharing means that a TCP/IP packet for a specific UE arrives at the serving TP or the centralized scheduler only, and the serving TP or the centralized scheduler determines an MCS and the number of transmitted RBs on the basis of scheduling decision, generates transport blocks and then transmits the generated transport blocks along with scheduling decision to the serving TP and Co-TP such that the serving TP and Co-TP share the information.

2.2.1 TCP/IP Packet Sharing

2.2.1.1 Centralized Scheduling+JT (Using Fast Backhaul)

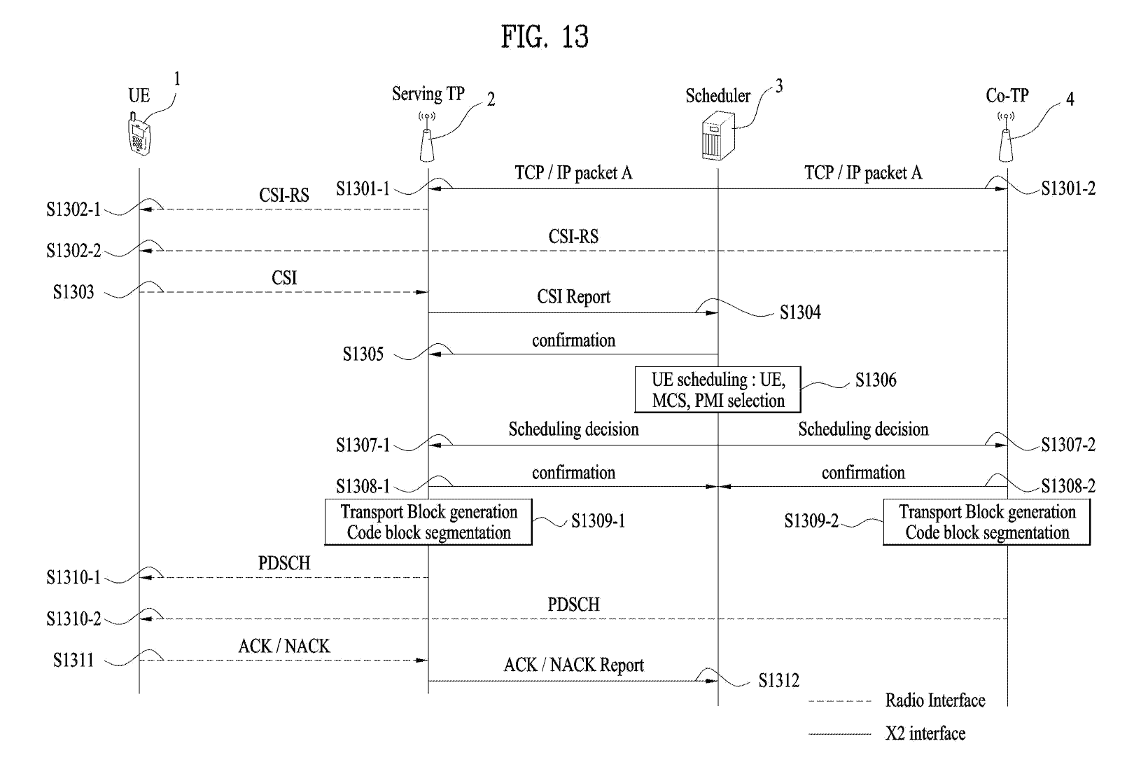

FIG. 13 shows CoMP operation according to JT when a centralized scheduler is present in a CoMP cluster. Since the performance of JT can be secured only in the case of fast backhaul (when latency is close to zero), a fast backhaul case is exemplified in the present embodiment.

TCP/IP packet A for a specific UE 1 may arrive at a serving TP 2 and a Co-TP 4 from the scheduler 3 (S1301-1 and S1301-2). The serving TP and the Co-TP (or CSI-RSs transmitted thereby) are included in a CoMP measurement set of the UE, and the UE may receive and measure the CSI-RSs transmitted from the two TPs (S1302-1 and S1302-2) and report corresponding CSI values to the serving TP (S1303). The serving TP may deliver the CSI report to the scheduler (S1304) and the scheduler may signal successful reception of the CSI report to the serving TP (S1305).

The scheduler may select a UE, an MCS and a PMI for the selected UE on the basis of the CSI report (S1306). In addition, the scheduler may transmit scheduling decision information including the selected UE, MCS, PMI and information about a timing at which each TP needs to transmit a PDSCH to the TPs having the TCP/IP packet of the corresponding UE (S1307-1 and S1307-2). The TPs may generate transport blocks on the basis of the received scheduling decision information and perform code block segmentation depending on a transport block size (S1308-1 and S1308-2). Then, the TPs may transmit the PDSCH on the basis of the scheduling decision information (S1309-1 and S1309-2). To this end, UL configuration information of the UE needs to be transmitted to the Co-TP in advance. The serving TP 2 may receive ACK/NACK for PDSCH transmission from the UE 1 and transmit the ACK/NACK to the scheduler for the following retransmission and scheduling (S1311).

2.2.1.2 Distributed Scheduling+JT (Using Fast Backhaul)

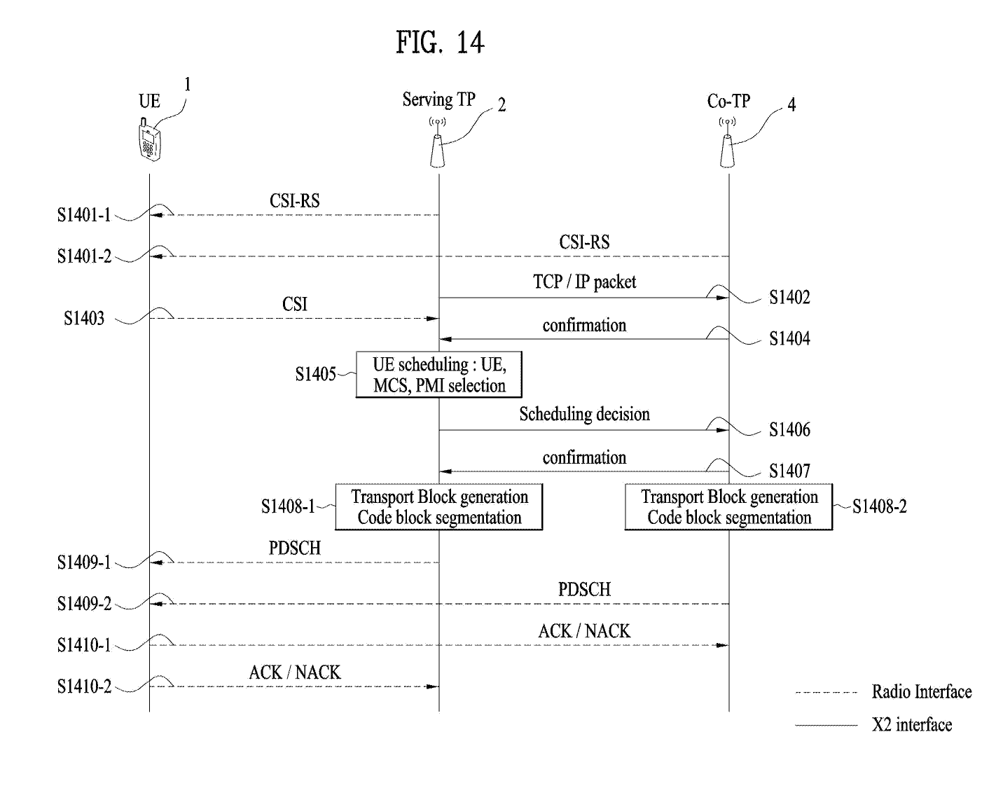

FIG. 14 shows JT when the centralized scheduler is not present in the CoMP cluster. Hierarchy of TPs needs to be semi-statically formed in a network in which a separate centralized scheduler is not present and TPs determine scheduling in a distributed manner. Since each TP attempts to transmit a PDSCH for a UE served thereby, it is necessary to decide a TP having priority to serve a UE corresponding thereto and a timing when the TP will serve the corresponding UE. Accordingly, in such a network structure, it is most important to determine priority of TPs for successful CoMP of the TPs.

Simply, priority for time resources can be separately determined through communication between TPs. The time resources are represented as periods and offsets and a specific TP has scheduling priority at a time (specific subframe or specific radio frame) represented by a specific period and offset. Alternatively, a time at which a specific TP has priority may be determined as a specific time pattern (e.g., a bitmap for radio frames and subframes). As a typical example, priority of TPs in an interval corresponding to N specific radio frames can be determined on a subframe basis. For example, when N=4, the TPs can exchange a 40-bit bitmap using the X2 interface through negotiation on time resources by means of the X2 interface.

Priority at/in a timing/interval can be determined in such a manner that the TPs generate random numbers and a TP having the largest random number at the corresponding timing/interval has priority. Alternatively, priority can be determined through coin tossing. In this case, information that needs to be preferentially exchanged during negotiation between the TPs can be a generated random number of a coin tossing result value. When the TPs exchange the 40-bit bitmap using the X2 interface through such negotiation, priority in the time resource region is determined and thus the TPs can perform scheduling in a distributed manner.

Similarly, priority of the TPs in the frequency resource region can be determined. The entire frequency can be divided into M arbitrary blocks and different TPs can have scheduling priority in the respective blocks. A method of determining priority of the TPs in each block may be similar to the aforementioned method of determining priority in the time resource region. In this case, each TP can generate a random number or perform coin tossing. A random number or a coin tossing result generated by each TP per block can be exchanged through the X2 interface and priority can be determined through this procedure.

An embodiment of the present invention will now be described with reference to FIG. 14. The serving TP 2 of the UE 1 and the Co-TP 4 belonging to the CoMP measurement set of the UE can transmit CSI-RSs (S1401-1 and S1401-2). The serving TP having priority at specific time and in a specific frequency region can transmit a TCP/IP packet of the UE to the Co-TP (S1402). The Co-TP can transmit acknowledgement for reception of the TCP/IP packet to the serving TP (S1404). The serving TP can receive CSI about the CSI-RS from the UE (S1403).

The serving TP can perform CoMP scheduling for the UE on the basis of the CSI from the UE (S1405). The serving TP can select a UE and select an MCS level and a PMI for the selected UE. The serving TP can generate scheduling decision information including information about a timing when a PDSCH needs to be transmitted in addition to the selected information and transmit the scheduling decision information to the Co-TP (S1406). The Co-TP can transmit acknowledgement for reception of the scheduling decision information to the serving TP (S1407).

The serving TP and the Co-TP can generate transport blocks and perform code block segmentation on the basis of the scheduling decision information (S1408-1 and S1408-2) and transmit PDSCHs to the UE at the scheduled timing (S1409-1 and S1409-2). The UE can transmit ACK/NACK for the PDSCHs to the serving TP and the Co-TP (S1410-1 and S1410-2). In this case, the Co-TP needs to know UL configuration information related to ACK/NACK transmission of the UE in advance in order to receive the ACK/NACK transmitted from the UE. The UL configuration information can be exchanged prior to scheduling corresponding to S1405, for example, at CoMP measurement set decision timing.

2.2.2 Transport Block Sharing

2.2.2.1 Centralized Scheduling+JT (Using Fast Backhaul)

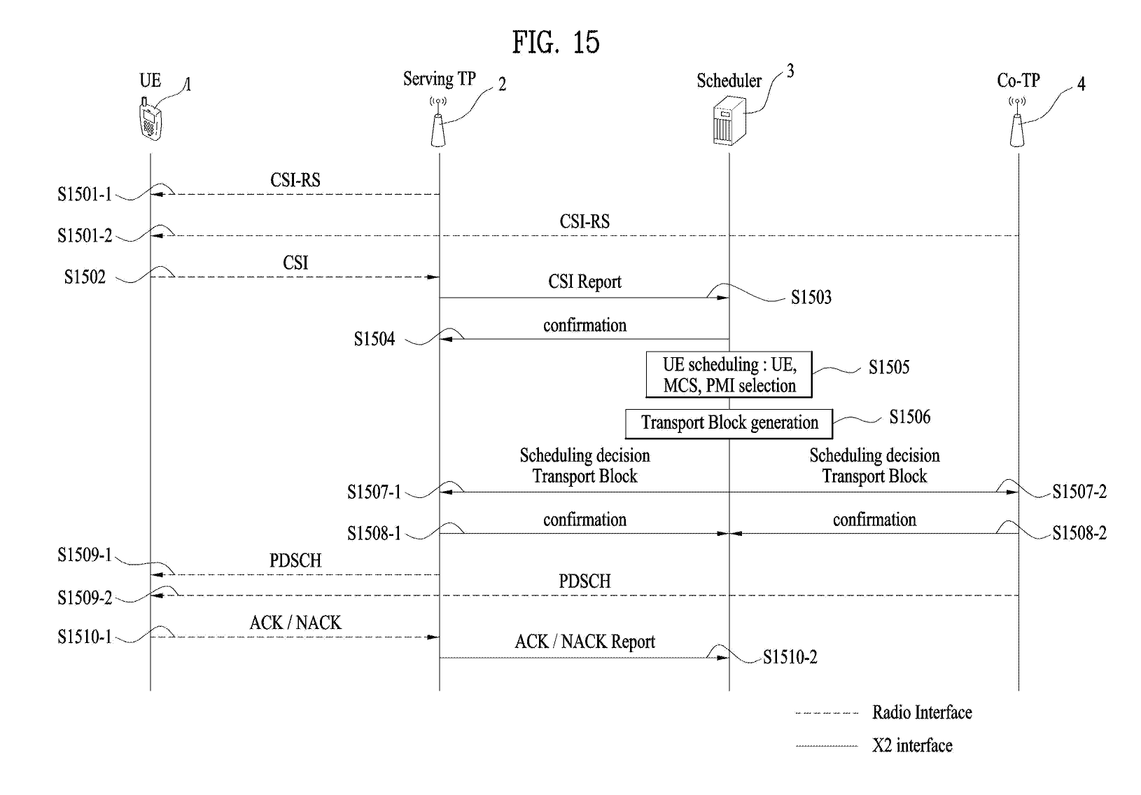

FIG. 15 shows CoMP operation according to JT when the centralized scheduler is present in the CoMP cluster. The serving TP 2 of the UE 1 and the Co-TP 4 belonging to the CoMP measurement set of the UE can transmit CSI-RSs (S1501-1 and S1501-2). The UE can receive and measure the CSI-RSs and transmit CSI to the serving TP (S1502). The serving TP can deliver the CSI to the scheduler 3 (S1503). The scheduler can transmit acknowledgement for delivery of the CSI to the serving TP (S1504).

The scheduler can select a UE on the basis of the CSI and perform UE scheduling for selecting an MCS level and a PMI for the selected UE (S1505). In addition, the scheduler can generate a transport block according to the scheduling (S1506). The scheduler can transmit scheduling decision information including the selected information and information about a timing of PDSCH transmission to the UE to the serving TP and the Co-TP (S1507-1 and S1507-2). Here, a transport block corresponding to the scheduling decision information needs to be transmitted to the serving TP and the Co-TP. Upon reception of the transport block, the serving TP and the Co-TP can perform code block generation and segmentation depending on the size of the scheduled transport block. Then, the serving TP and the Co-TP can transmit PDSCHs to the UE at scheduled timing (S1509-1 and S1509-2). The UE can transmit ACK/NACK for reception of the PDSCHs to the serving TP and the Co-TP (S1510-1 and S1510-2).

When the centralized scheduler is present, it can be assumed that all TCP/IP packets arrive at the scheduler. If TCP/IP packets arrive only at the serving TP, the serving TP needs to generate a transport block and to transmit the generated transport block to the Co-TP upon reception of the scheduling decision information.

2.2.2.2 Distributed Scheduling+JT (Using Fast Backhaul)

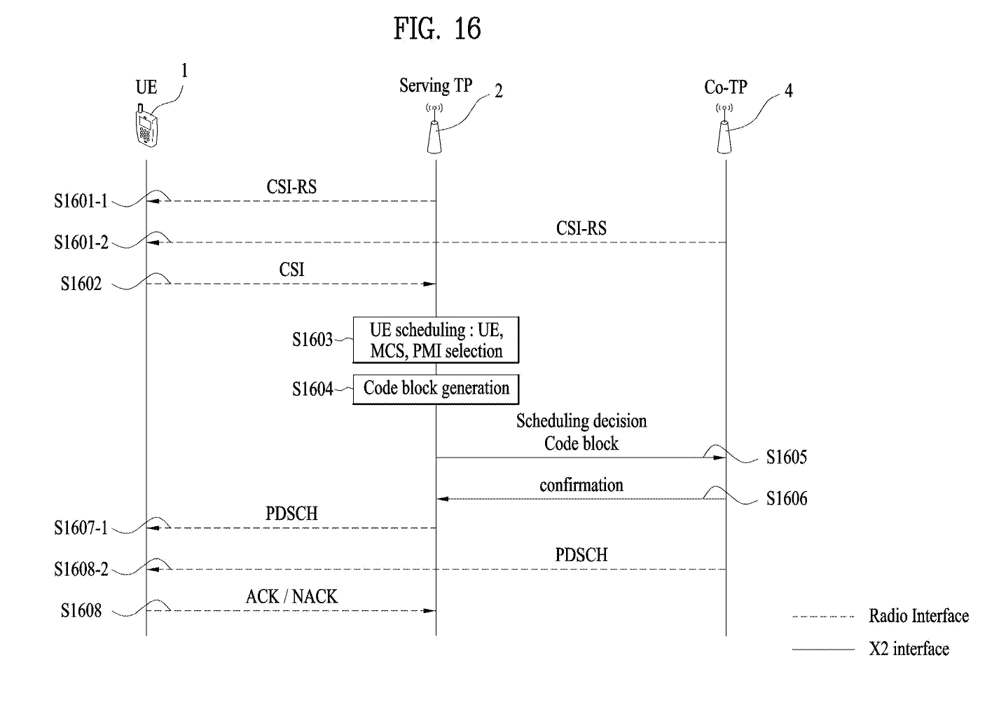

FIG. 16 shows an example of performing JT when distributed scheduling is performed without the centralized scheduler in the CoMP cluster. Operation according to a radio interface refers to the aforementioned embodiments and description thereof is omitted in the present embodiment.

The serving TP2 can make a scheduling decision for selecting a UE, an MCS and a PMI for the selected UE (S1603) and generate a code block according to the scheduling decision (S1604). Then, the serving TP can transmit the generated code block along with scheduling decision information to the Co-TP 4 (S1605). The Co-TP can transmit acknowledgement for reception of the scheduling decision information and the code block to the serving TP (S1606). The serving TP and the Co-TP can transmit PDSCHs at the same timing on the basis of the scheduling decision information and the code block.

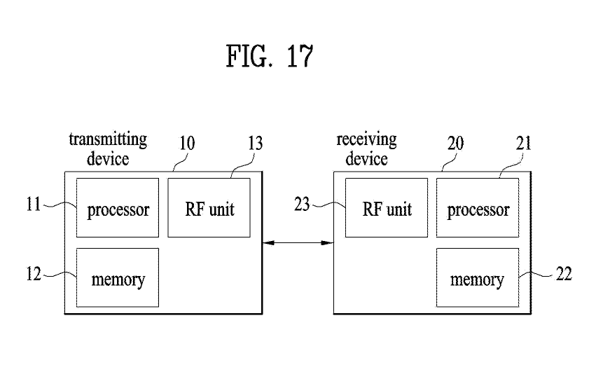

FIG. 17 is a block diagram of a transmitting device 10 and a receiving device 20 configured to implement exemplary embodiments of the present invention. Referring to FIG. 17, the transmitting device 10 and the receiving device 20 respectively include transmission and reception units 13 and 23 for transmitting and receiving radio signals carrying information, data, signals, and/or messages, memories 12 and 22 for storing information related to communication in a wireless communication system, and processors 11 and 21 connected operationally to the transmission and reception units 13 and 23 and the memories 12 and 22 and configured to control the memories 12 and 22 and/or the transmission and reception units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the transmission and reception unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the transmission and reception unit 13 may include an oscillator. The transmission and reception unit 13 may include Nt (where Nt is a positive integer) transmit antennas.

A signal processing process of the receiving device 20 is the reverse of the signal processing process of the transmitting device 10. Under the control of the processor 21, the transmission and reception unit 23 of the receiving device 10 receives RF signals transmitted by the transmitting device 10. The transmission and reception unit 23 may include Nr receive antennas and frequency down-converts each signal received through receive antennas into a baseband signal. The transmission and reception unit 23 may include an oscillator for frequency down-conversion. The processor 21 decodes and demodulates the radio signals received through the receive antennas and restores data that the transmitting device 10 wishes to transmit.

The transmission and reception units 13 and 23 include one or more antennas. An antenna performs a function of transmitting signals processed by the transmission and reception units 13 and 23 to the exterior or receiving radio signals from the exterior to transfer the radio signals to the transmission and reception units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

In regard with an X2 interface, a scheduler, eNB and/or TP may function as a transmitting device or receiving device. The transmission and reception units may be hardware and/or software which function as interfaces in connection with wired- or wireless communication.

The transmitting device and/or the receiving device may be configured as a combination of one or more embodiments of the present invention.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

The present invention is applicable to wireless communication devices such as a terminal, a relay, a base station, etc.

What is claimed is:

1. A method for supporting communication of a coordinated multi-point transmission and reception (CoMP) cluster by a CoMP scheduling device in a wireless communication system supporting CoMP, the method comprising:
receiving channel state information (CSI) measured by at least one terminal served by at least one base station in the CoMP cluster;
selecting one or more terminals to be served through a CoMP operation based on the received CSI measured by the at least one terminal and determining scheduling information for the selected terminals; and
transmitting the scheduling information for the selected terminals to at least one base station for serving the CoMP operation of the selected terminals.

2. The method according to claim 1, wherein the scheduling information for the selected terminals includes at least one of identifiers of the selected terminals, modulation and coding scheme (MCS) and a precoding matrix indicator (PMI) allocated to the selected terminals.

3. The method according to claim 1, wherein the scheduling information for the selected terminals includes at least one of the identifiers of the selected terminals, information about resource block and PMIs allocated to the selected terminals.

4. The method according to claim 1, wherein the at least one base station transmits downlink data to the selected terminals based on the scheduling information for the selected terminals, and only one base station from among the at least one base station transmits downlink data to one of the selected terminals at a specific timing.

5. The method according to claim 4, further comprising acquiring feedback information about reception of the downlink data from the selected terminals.

6. The method according to claim 1, wherein the CoMP scheduling device is a base station in the CoMP cluster.

7. The method according to claim 1, further comprising transmitting a specific TCP/IP packet for the selected terminals to at least one base station in the CoMP cluster prior to the determining of the scheduling information.

8. The method according to claim 7, further comprising generating a transport block based on the scheduling information.

9. A method for performing communication of a CoMP cluster by a base station in the CoMP cluster in a wireless communication system supporting CoMP, the method comprising:
transmitting CSI, measured by at least one terminal served by the base station, to a scheduling device; and
receiving, from the scheduling device, scheduling information for one or more terminals to be served through a CoMP operation selected based on the CSI measured by the at least one terminal.

10. The method according to claim 9, wherein the scheduling information for the selected terminals includes at least one of identifiers of the selected terminals, modulation and coding scheme (MCS) and a precoding matrix indicator (PMI) allocated to the selected terminals.

11. The method according to claim 9, wherein the scheduling information for the selected terminals includes at least one of the identifiers of the selected terminals, information about resource block and PMI allocated to the selected terminals.

12. The method according to claim 11, further comprising selecting an MCS for the selected terminals.

13. The method according to claim 9, further comprising transmitting downlink data to the selected terminals based on the scheduling information for the selected terminals,
wherein the base station is a unique base station transmitting downlink data to one of the selected terminals at a specific timing.

14. The method according to claim 13, further comprising acquiring feedback information about reception of the downlink data from the selected terminals.

15. The method according to claim 9, further comprising receiving a specific TPC/IP packet for the selected terminals from the scheduling device prior to transmitting CSI.

16. The method according to claim 15, further comprising generating a transport block based on the scheduling information and segmenting a code block according to a size of the generated transport block.
